(19) United States
(12) Patent Application Publication
(10) Pub. No.: US 2005/0187800 A1
(43) Pub. Date: Aug. 25, 2005

(54) Integrating defined contribution accounts into a claim payment processing system

(76) Inventor: Craig P. Luftig, Union, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/784,105

(22) Filed: Feb. 20, 2004

(51) Int. Cl. G06F 17/60

(52) U.S. Cl. 705/4

(57) ABSTRACT

Disclosed is a system to integrate a defined contribution health plan with a traditional health plan that includes a claim processing system, a health plan management software module, and a defined contribution management software module integrated with the health plan management software module. Both the health plan management and defined contribution software modules are operable by the claim processing system to: create a defined contribution application for the health plan to allow for the entry of information for the defined contribution plan; link defined contribution plan information to the health plan; and establish allocation rules and amounts for the defined contribution plan. As part of claim processing, a claim payment to a member or provider based on the defined contribution plan may be made.

### FIELD

Embodiments of the invention relate to the field of claim payment processing systems. More particularly, embodiments of the invention relate to integrating defined contribution accounts into a claim payment processing system.

### DESCRIPTION OF RELATED ART

The cost of medical care in the United States continues to increase at ever escalating rates—well beyond the rate of inflation. In an effort to help make healthcare more affordable for consumers, the Federal government has enabled the establishment of certain tax-favored health care funding vehicles.

Typically, defined contribution plans are tax-exempt spending accounts that are generally used in conjunction with more traditional health plans. They can be used to cover health care and/or dependent care, such as a child's daycare expenses.

In fact, defined contribution accounts are the fastest-growing segment of the health insurance industry, and their market share is expected to increase exponentially in coming years. They combine the advantages of tax breaks and greater freedom of choice for customers with cost control for insurance providers and businesses

Presently, there are two major types of defined contribution accounts, Health Reimbursement Arrangements (HRAs) and Flexible Spending Accounts (FSAs). Flexible Spending Accounts allow members to contribute money on a pre-tax basis to an account that can be used for both health care expenses and dependent care. Members are reimbursed for eligible out-of-pocket expenses from the account, and any unused funds at the end of the year are forfeited.

Health Reimbursement Arrangements, on the other hand, must be used strictly for health care expenses, and act as a supplement to the traditional health care plan. Members are given a health plan with a relatively high deductible, and are allocated a set amount of money by their employer, which may be used at the employer's discretion for health expenses. If the deductible is not met, health expenses are paid for out of the HRA. There is typically a gap between the two during which the member is responsible for his or her own expenses. Any remaining HRA contributions may be carried over to the next year.

For example, an employer allots $2,000 to an employee for an HRA, and a traditional health care plan with a deductible of $3,500 is purchased. The employee pays full prices for medical and hospital care, plus prescription medications out of the HRA until the initial $2,000 is completely spent, then assumes responsibility for all expenditures for the next $1,500 until the $3,500 deductible is reached. The traditional health care plan then takes effect.

Unfortunately, although defined contribution accounts are a rapidly-growing segment of the health insurance industry, defined contribution accounts have still not been fully integrated into the claim payment processing systems of health plans.

### BRIEF DESCRIPTION OF THE DRAWINGS

FIG. 1 is a block diagram illustrating an example of a system in which a health plan having a claim payment processing system including embodiments of the invention related to integrating defined contribution accounts may be implemented.

FIG. 2 is a block diagram illustrating the components of the health plan integrating defined contribution functionality, according to one embodiment of the invention.

FIG. 3 is a flow diagram illustrating a process of integrating defined contribution accounts into a claim payment processing system of a health plan, according to one embodiment of the invention.

FIG. 4 is a flow diagram illustrating a process to implement the creation of an HRA plan in a health plan integrating defined contribution functionality, according to one embodiment of the invention.

FIG. 5 is a flow diagram illustrating a process to establish allocation rules and amounts for a health plan utilizing an HRA, according to one embodiment of the invention.

FIG. 6A illustrates an example of a graphical user interface that may be utilized in the creation of an HRA and particularly illustrates a user interface for HRA administrative functionality, according to one embodiment of the invention.

FIG. 6B illustrate an example of a graphical user interface to enter HRA allocation rules, according to one embodiment of the invention.

FIG. 7 is a flow diagram illustrating a process to perform claim processing with an HRA account integrated into a health plan, according to one embodiment of the invention.

FIG. 8 illustrates a graphical user interface that may be used in claim processing applications with an HRA or an FSA integrated with a health plan, according to one embodiment of the invention.

FIG. 9 illustrates an example of a graphical user interface that may be accessed by a member, provider, employer, health plan, etc., in order to display claim payments and liabilities with regards to a health plan, particularly including HRA amounts, according to one embodiment of the invention.

FIG. 10 is a flow diagram illustrating a process to implement the creation of an FSA plan in a health plan integrating defined contribution functionality, according to one embodiment of the invention.

FIG. 11 is a flow diagram illustrating a process to establish allocation rules and amounts for a member of a health plan utilizing an FSA, according to one embodiment of the invention.

FIG. 12 illustrates an example of a graphical user interface that may be utilized in the creation of an FSA and particularly illustrates a user interface for FSA administrative functionality, according to one embodiment of the invention.

FIG. 13 is a flow diagram illustrating a process to perform claim processing with an FSA integrated into a health plan, according to one embodiment of the invention.

FIG. 14 illustrates an example of a claim inquiry graphical user interface that may be accessed by a member or employer to detail the status of a claim of an FSA account, according to one embodiment of the invention.

### DETAILED DESCRIPTION

In the following description, the various embodiments of the invention will be described in detail. However, such details are included to facilitate understanding of the invention and to describe exemplary embodiments for employing the invention. Such details should not be used to limit the invention to the particular embodiments described because other variations and embodiments are possible while staying within the scope of the invention. Furthermore, although numerous details are set forth in order to provide a thorough understanding of the embodiments of the invention, it will be apparent to one skilled in the art that these specific details are not required in order to practice the embodiments of the invention. In other instances details such as, well-known methods, types of data, protocols, procedures, components, electrical structures and circuits, are not described in detail, or are shown in block diagram form, in order not to obscure the invention. Moreover, embodiments of the invention will be described in particular embodiments but may be implemented in hardware, software, firmware, middleware, or a combination thereof.

In the following description, certain terminology is used to describe various features of the embodiments of the invention. In general, a “network” comprises one or more end nodes having physical connections to one or more networking devices of the network. However, it should be appreciated that physical connections between peers are not always required, such as in, for example, a wireless system.

Generally, embodiments of the invention can be utilized in a network that is packetized, packet-switched, connectionless, or connection oriented, etc., and combinations thereof. Examples of networks include the Internet, wide area networks (WANs), local area networks (LANs), wireless networks, and combinations thereof. For example, networks may utilize Transmission Control Protocol/Internet Protocol (TCP/IP), Asynchronous Transfer Mode (ATM), Frame Relay (FR), Point-to Point Protocol (PPP), Systems Network Architecture (SNA), Voice over Internet Protocol (VoIP), or any other sort of protocol, and combinations thereof.

A network allows the communication of data traffic between any “end nodes” in the network using packets or other types of data transfer. An “end node” normally comprises a combination of hardware and/or software that constitutes the source or destination of the information. Examples of an end node includes any type of device connectable to a network such as a processing system, computing system, computer, server, file server, application server, computer, workstation, mainframe, network computer, palm pilot, personal digital assistant, fax machine, printer, cell-phone, and other computing devices.

A network is typically a data network that may contain switching and/or routing equipment designed to transfer digital data traffic. An example of the most commonly used network is the Internet.

Data traffic through the network may be of any type including data, voice, graphics, video, audio, e-mail, Fax, text, multi-media, documents and other generic forms of data. Data traffic generally comprises one or more signals having one or more bits of data, address, control or any combination thereof transmitted in accordance with any chosen scheme. Data traffic can be data, voice, address, and/or control in any representative signaling format or protocol.

Further, it should be noted that a computer, processing system, computing system, computing device, etc., refers to any sort of computing or networking device (e.g. computer, server, file server, application server, workstation, mainframe, network computer, lap-top computer, mobile computing device, palm pilot, personal digital assistant, cell-phone, integrated circuit, fax machine, printer, copier, set-top box, etc.) that includes at least one of a processor, a memory, input/output devices, etc.; and/or any other sort of device, machine, or system capable of implementing instructions.

Generally, embodiments of the invention relate to a system and method to integrate a defined contribution plan with a traditional health plan. For example, in one embodiment, the system includes a claim processing system, a health plan management software module, and a defined contribution management software module integrated with the health plan management software module. Both the health plan management and defined contribution software modules are operable by the claim processing system to: create a defined contribution application for the health plan to allow for the entry of information for the defined contribution plan; link defined contribution plan information to the health plan; and establish allocation rules and amounts for the defined contribution plan.

As part of claim processing, a claim payment to a member based on the defined contribution plan may be made. A member of the health plan utilizing a computing device can access a record of the claim payment for the defined contribution plan through a network (e.g. the Internet). Examples of defined contribution plans include Health Reimbursement Arrangements (HRAs) and Flexible Spending Accounts (FSAs).

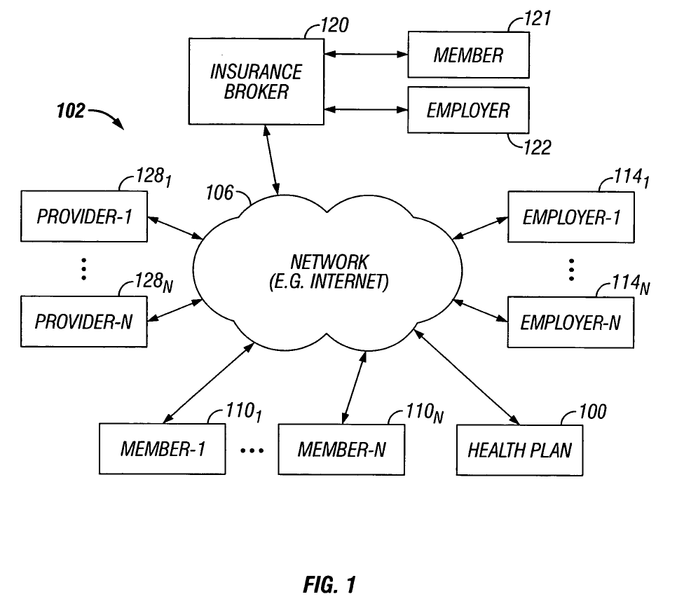

With reference to FIG. 1, FIG. 1 is a block diagram illustrating an example of a system 102 in which a health plan 100 having a claim payment processing system including embodiments of the invention related to integrating defined contribution accounts may be implemented. The health plan 100 may be coupled through the network 106 to a plurality of other entities. The network 106 may include one or more types of networks, as previously discussed. As one particular example, the network 106 includes the Internet.

As show in FIG. 1, the health plan 100 may be coupled through the network 106 to a plurality of members 110 (Member-1 110₁ . . . Member-N 110_{N}), a plurality of providers 128 (Provider-1 128₁ . . . Provider-N 128_{N}), a plurality of employers 114 (Employer-1 114₁ . . . Employer-N 114_{N}), and one or more insurance brokers 120.

Typically, the health plan 100 is an insurance organization, such as BLUE CROSS or AETNA, which is involved in the field of claim payment processing. Typical health plan functions include: the enrollment and management of members 110 and employers 114; accounting; claim processing to determine the allowance or denial of claims; and providing payments to providers 128 and members 110.

Members 110 are typically subscribers to a health plan 100 and may or may not be affiliated with an employer 114. Employers 114 generally contract with a health plan 100 to provide health coverage for their members 110. Providers 128 provide health care services to members 110 and are typically paid by the health plan 100. Examples of providers include hospitals, doctors, dentists, etc. An insurance broker 120 typically acts as a broker for the health plan 100 to sell and/or manage insurance plans for members 110 and employers 114.

In the example illustrated in FIG. 1, the various entities including members 110, employers 114, providers 128 and insurance brokers 120 may include suitable computing devices and/or systems (e.g. end nodes) to communicate over network 106 with appropriate computing devices and/or systems of the health plan 100. However, it should be appreciated that the entities can communicate with the health plan 100 through other means, such as by regular mail, person-to-person telephone communication, etc., as well, or in lieu thereof. FIG. 1 is merely illustrative of a computer-based network.

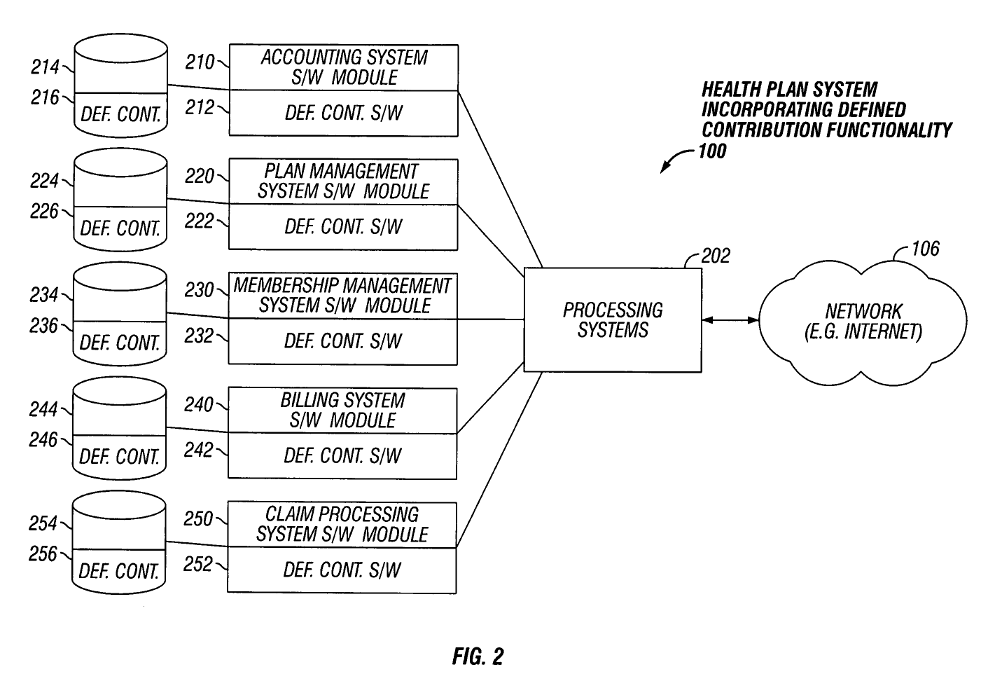

Turning to FIG. 2, FIG. 2 is a block diagram illustrating the components of the health plan system 100 integrating defined contribution functionality. As shown in FIG. 2, the health plan system 100 includes claim payment processing systems 202, typically including a plurality of computing systems designed for claim payment processing, coupled to the network 106 for the receipt and transmission of data traffic. It should be appreciated that claim payment processing systems 102 may be coupled to the network 106 by a suitable network interface(s). The health plan system 100 utilizing claim payment processing systems 202, implements a variety of software modules to perform claim payment processing functionality. In embodiments of the present invention, particular software modules, as will be discussed, include integrated defined contribution software modules to allow the claim payment processing systems 202 to integrate defined contribution accounts.

Particularly, the health plan system integrating defined contribution functionality 100 may include an accounting system software module 210 that includes an accounting defined contribution software module 212. These accounting software modules may be coupled to data storage 214 which may have a data storage area 216 reserved for defined contribution accounts. The accounting defined contribution software module 212 is integrated with the accounting system software module 210 to integrate defined contribution accounts into accounting functionality implemented by the health plan 100.

The health plan system integrating defined contribution functionality 100 may also include a plan management system software module 220 that includes a plan management defined contribution software module 222. These software modules may be coupled to plan management data storage 224, which may have a data storage area 226 for defined contribution plans. The plan management defined contribution software module 222 is integrated with the plan management system software module 220 in order to integrate defined contribution accounts into plan management functionality implemented by the health plan 100.

The health plan system integrating defined contribution functionality 100 further includes a membership management software module 230 that includes membership management defined contribution software module 232. These software modules may be coupled to data storage 234, which may have a memory storage area 236 for defined contribution plans. The membership management defined contribution software module 232 is integrated with the membership management system software module 230 in order to integrate defined contribution accounts into membership management functionality implemented by the health plan 100.

The health plan system integrating defined contribution functionality 100 may additionally include a billing system software module 240 that includes a billing system defined contribution software module 242. These software modules may be coupled to a data storage area 244 which may have a data storage area for defined contribution plans 246. The billing system software module 242 is integrated with the billing system software module 240 in order to integrate defined contribution accounts into the billing system functionality implemented by the health plan 100.

The health plan system integrating defined contribution functionality 100 may further include a claim processing system software module 250 that includes a claim processing defined contribution software module 252. These software modules may be coupled to a data storage area 254 which may have a data storage area for defined contribution plans 256. The claim processing defined contribution software module 252 is integrated with the claim processing system software module 250 in order to integrate defined contribution accounts into claim processing functionality implemented by the health plan 100.

In one embodiment, the health plan system software, which is utilized with embodiments of the invention related to defined contribution functionality, may be the FACETS line of software products created by the TriZetto® Group, Inc.

It should be appreciated that the previously described system software modules for the health plan system integrating defined contribution functionality 100 is merely for explanatory purposes. Those of skill in the art will recognize that the described functionalities may be broken up into any number of different software modules and data storage arrangements and may be implemented by a wide variety of different types of computing systems of differing configurations.

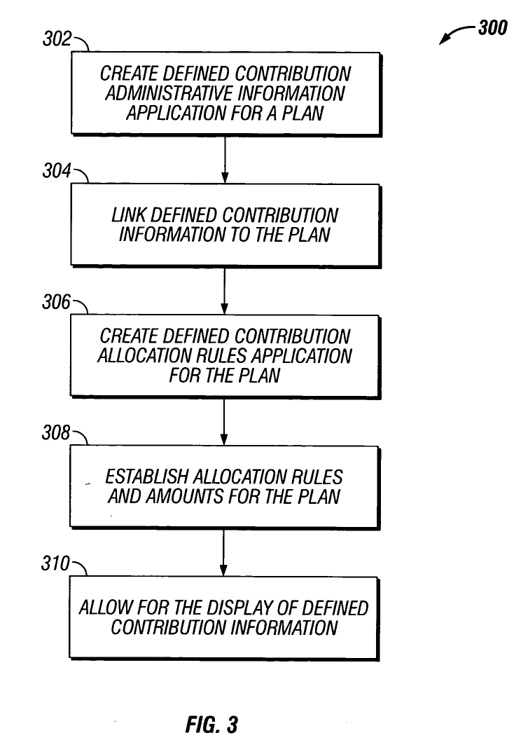

Turning now to FIG. 3, FIG. 3 is a flow diagram illustrating a process 300 of integrating defined contribution accounts into a claim payment processing system of a health plan. At block 302, a defined contribution administrative information application is created for a particular health plan. Next, defined contribution information is linked to the plan (block 304). Then a defined contribution allocation rules application is created for the health plan (block 306). Allocation rules and amounts for the health plan are also established (block 308). Thus, defined contribution applications are created that allow for the entry of information for the defined contribution plan. Additionally, the display of defined contribution information is allowed for members, providers, employers, the health plan, etc. (block 310).

In one embodiment, as in FIG. 2, the plan management system software module and membership system software module, in conjunction with their respective defined contribution software modules as previously discussed, may be utilized in the creation of the defined contribution administrative information application, the creation of the defined contribution allocation rules application, and the establishment of the allocation rules and amounts for the plan. Defined contribution information may be stored at any suitable location within the health plan system. For example, defined contribution information in relation to plan management and membership management may be stored in their respective data storage areas, as previously discussed.

Further, in one embodiment, members, employers, providers, and the health plan itself can access defined contribution information through the network 106 for their own use. In one example, a member, employer, provider, or the health plan itself may access defined contribution information (to which they have proper security access) through the network 106 using their own computing device for display on their own computing device.

Particularly, defined contribution information can be displayed to a user having some sort of computing device over the network 106. For example, the health plan system integrating the defined contribution functionality 100 includes processing systems 202 including servers having conventional software modules for transmitting and receiving data to and from computing devices over the network 106, such as the Internet. For example, using the Hypertext Transfer Protocol (HTTP) and Hypertext Markup Language (HTML) or Extensible Markup Language (XML), a server of the health plan can communicate with a member, provider, employer, or the health plan itself, etc., across the network to provide various functions and data. For example, a member having a computing device may utilize an embedded browser which is part of an application software module or typical browser such as Netscape®, Internet Explorer®, etc., to supply data to and to access data from the health plan system.

In one embodiment, particular types of defined contribution accounts including Health Reimbursement Accounts (HRAs) and Flexible Spending Accounts (FSAs) may be integrated with a health plan system. By utilizing the previously described system, defined contribution accounts may be seamlessly integrated into a claim payment processing system and are scalable. Further, this system may be utilized to extend direct enrollment and reporting to members and employers through the Internet, and allows members to become more involved with benefit selection and management of available allocation dollars. This is increasingly important because defined contribution plans are a rapidly growing type of health care plan, are endorsed and encouraged by the government by their favorable tax status, and need to be integrated with the claim processing systems of health care plans.

As will be described in more detail below, the health plan system integrating defined contribution functionality provides a fully integrated approach that allows for flexible carryover amounts, a fully configurable HRA/FSA payment hierarchy, automation of carryover amounts, claims payment and recycling, and automated creation of employee allocation balances.

One particular type of defined contribution plan is a Health Reimbursement Arrangement (HRA) type of plan. HRAs are typically administered in conjunction with a traditional insurance plan. HRAs are used strictly for qualified health care expenses, and act as a supplement to the traditional health care plan. Generally, members are given a health plan with a relatively high deductible, and are allocated a set amount of money by their employer, which may be used at their discretion for health expenses. If the deductible is not met, health expenses are paid out of the HRA. There is typically a gap between the two during which the member is responsible for his or her own expenses. Any remaining HRA contributions may be carried over to the next year.

As will be described, embodiments of the invention provide for functionality related to: integrating HRAs with health plans; dealing with subscriber/family allocation amounts; reimbursing members for covered Internal Revenue Service (IRS) code section 213 expenses; optional year-end carryover of unused amounts; paid claims and account balance inquiry tools; etc.

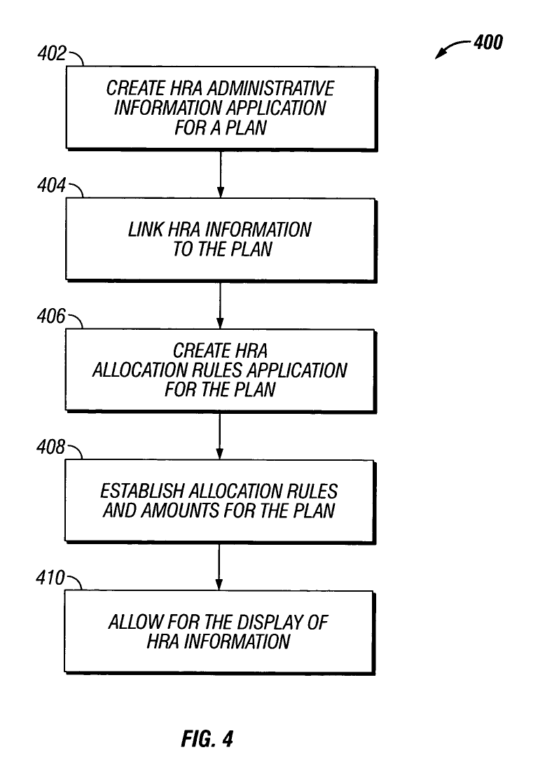

With reference now to FIG. 4, FIG. 4 is a flow diagram illustrating a process 400 to implement the creation of a HRA plan in a health plan system integrating defined contribution functionality. In order to accommodate the setup of an HRA plan, an HRA administrative information application is created for a health plan. The creation of the HRA administrative information application allows HRA information to be linked to a particular health plan. Next, at block 404, the HRA information is linked to the health plan. Further, an HRA allocation rules application is created for the plan (block 406). Next, allocation rules and amounts are established for the plan utilizing the HRA allocation rules application (block 408). Further, HRA information is configured for display to members and employers who may access this information via a network.

In one embodiment, as in FIG. 2, the plan management system software module and the membership management system software module in conjunction with their respective defined contribution software modules, as previously discussed, may be utilized in the creation of the HRA administrative information application, the creation of the HRA allocation rules application, and the establishment of allocation rules and amounts for the health plan.

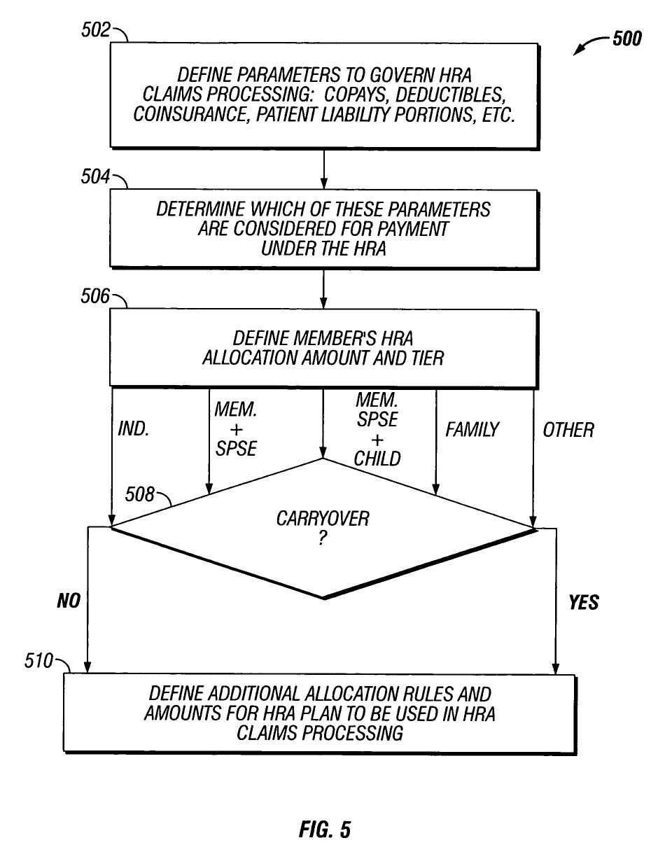

Turning now to FIG. 5, FIG. 5 is a flow diagram illustrating a process 500 to establish allocation rules and amounts for a health plan utilizing an HRA. In order to process HRA transactions, parameters are defined that govern how HRA claims are processed. Particularly, parameters including co-pays, deductibles, co-insurance, patient liability portions, etc., are defined to govern HRA claims processing (block 502). Next, for the particular plan, it is determined which of these parameters are considered for payment under the HRA (block 504).

Particularly, as previously discussed, HRA allocation rules are used to define a member's HRA allocations, and to allow for the definition of allocation methods and amounts, and whether remaining allocations will carry over to the following year.

Thus, the process 500 next defines a member's HRA allocation amount and tier (block 506). The allocation may be varied by four coverage tiers: individual; member and spouse; member/spouse and one child; or full family. Also, other types of coverage tiers may be established. For example, HRA rules can be specifically developed for an employer group or can be shared among multiple groups. Also, at block 508, it is determined whether or not the HRA includes a carry-over option in which funds that were not used in the current year are carried over to the next year. For example, the carry-over option may be determined by the employer.

Further, other additional allocation rules and amounts for the HRA of the plan may be defined (block 510). These additional allocation rules and amounts for the HRA of the plan may be used in a HRA claims processing as will be discussed later.

Links to appropriate HRA allocation data and HRA qualified medical expense data may also be established, as well as explanation of benefit (EOB) options for claims involving HRA payments. HRA plan applications may also allow for the variation of the percentage of HRA expenses to be reimbursed by the employer or health plan. Options can additionally be set to define whether a service is eligible for reimbursement from an HRA account only. Further, rules can be established as to which services are covered by the HRA and which services are not. This allows for pricing of non-covered services such as annual physicals. Additional service rule options may be attached to existing service codes without requiring the addition of new service codes to accommodate HRA requirements.

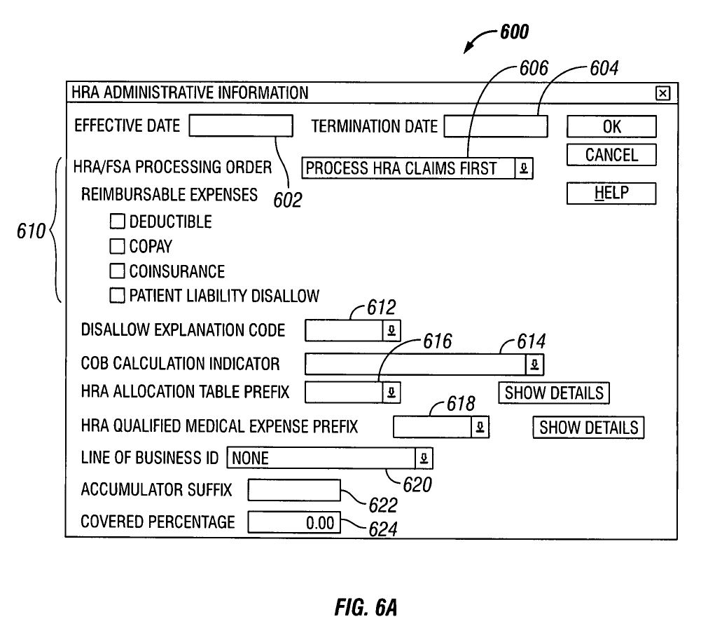

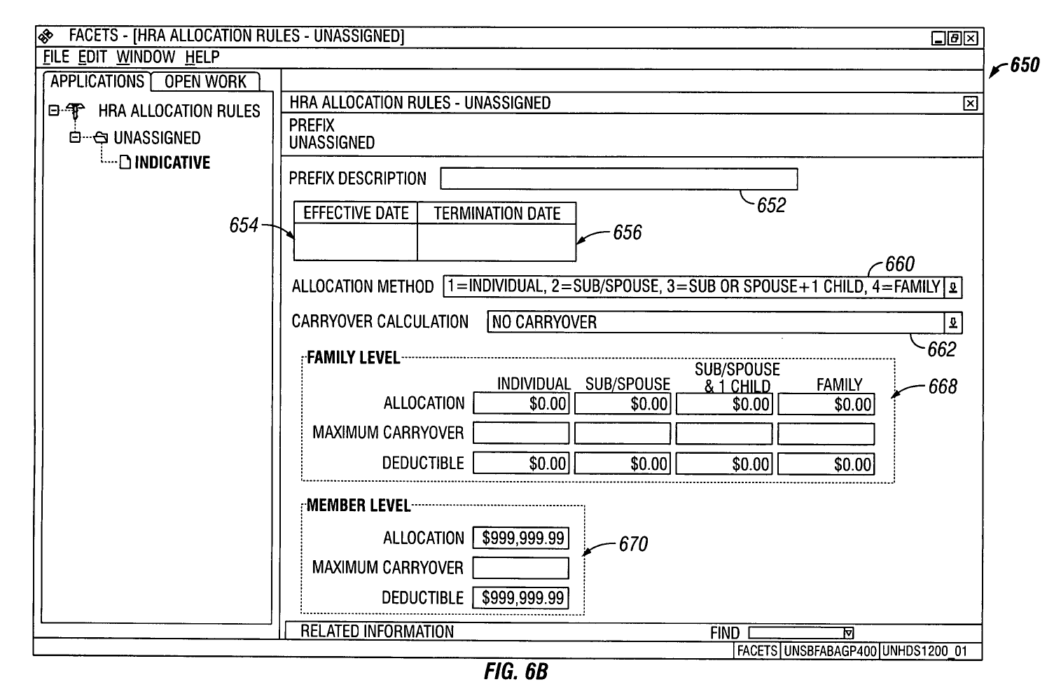

Turning now to FIG. 6A, FIG. 6A shows an example of a graphical user interface 600 that may be utilized in the creation of an HRA and particularly illustrates a user interface for HRA administrative functionality. As can be seen in FIG. 6A, the user interface includes an effective date field 602 to enter the date that the set of HRA administrative information became effective. A termination date field 604 allows for the entry of a date that the set of HRA administrative information was terminated. The user interface 600 further includes an HRA/FSA processing order field 606, which allows for the selection of HRA processing first or FSA processing first.

Further, the user interface 600 includes four fields 610 that may be selectable in any combination to define the types of reimbursable expenses. These include a deductible field for the selection of the reimbursement of deductible amounts. A copay field for the selection of reimbursement of copay amounts. A coinsurance box for the selection of the reimbursement of coinsurance amounts. Also, a patient liability disallow box is selectable for the reimbursement of the value calculated by a patient liability extension for patient liability disallows.

The user interface 600 also includes a disallow explanation code selection list 612 that is used to select a user-defined explanation code to value disallowed amounts when insufficient funds exist in the HRA account. Also, the user interface 600 includes a coordination of benefits (COB) calculation indicator 614 that allows for the selection of a starting point for HRA calculations when COB is involved. For example, one selection may include only selected patient liability options whereas another option may be to include all patient liability.

Further, the user interface 600 includes an HRA allocation table prefix 616, which selects a set of HRA allocation rules to link to the particular health plan. Additionally, a HRA qualified medical expense prefix selection list 618 may be provided that is used to select a set of HRA qualified medical expenses for linkage to the particular health plan.

A line of business ID selection list 620 may be provided to select the line of business related to the funds dispersed from the HRA account. Further, an accumulator suffix input box 622 may be provided to allow the entry of a suffix to track HRA accumulators. Also, a covered percentage entry box 624 may be provided to allow for the entry of the percentage, to multiply the HRA allowable amount by, to determine a final payment.

Turning now to FIG. 6B, FIG. 6B illustrates a graphical user interface 650 to enter HRA allocation rules. As shown in FIG. 6B, there is a prefix description field 652 to identify a set of HRA allocation rules. The HRA allocation rules are parameters for rules established by an employer group that are used to define a member's HRA allocations.

Further, effective date 654 and termination date 656 fields are provided such that, in the effective date field, the date that the set of HRA allocation rules became effective is displayed, and the date that the set of HRA allocation rules was terminated is displayed in the termination date field 656.

Further, an allocation method selection list 660 is provided that allows for the selection of an allocation method including: individual, subscriber/spouse, subscriber or spouse plus child, family, etc. Also, a carryover calculation selection field 662 is provided to allow for the selection for the type of carryover, such as, carryover all the remaining balance, carry over the lesser of the remaining balance or a maximum carryover amount, carryover the lesser of a remaining balance or the sum of the maximum carryover amount plus a prior years carryover, no carryover, etc.

A family level allocation parameter set 668 is also provided to allow for maximum allocation amounts, maximum carryover amounts, and deductible amounts which may be set for each of the differing types of tier levels such as individual, subscriber/spouse, subscriber/spouse plus child, and family.

Also, a member level allocation parameter field 670 is provided to allow for the entry at the member level of items including: maximum allocation, maximum carryover, and deductible.

It should be appreciated that the previously discussed graphical user interfaces are just one example of user interfaces that may be utilized to aid in implementing certain components of the previously described methods for the creation, management, and integration of HRA's with health plans.

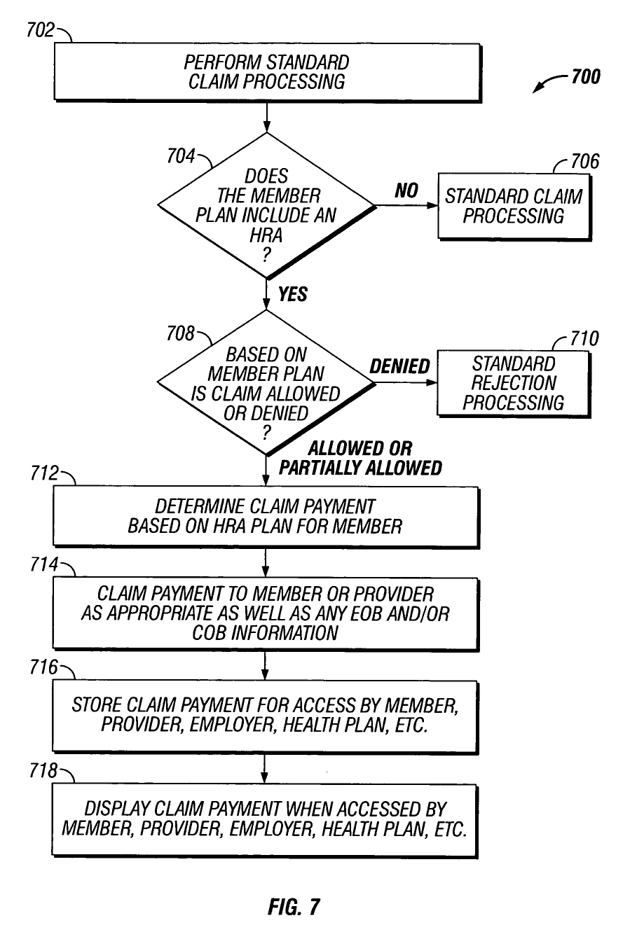

With reference now to FIG. 7, FIG. 7 is a flow diagram illustrating a process 700 to perform claim processing with an HRA integrated into a health plan. At block 702, standard claim processing is performed. The process 700 then determines whether the member plan includes an HRA (block 704). If not, standard claim processing is performed (block 706). If the member plan does include an HRA, it is next determined whether based on the member's health plan the claim is allowed or denied (block 708). If the claim is denied, standard rejection processing is performed (block 710). It should be appreciated that standard claim processing is well known in the art and involves the adjudication of claims based on such parameters as eligibility, provider contracting, pricing schedules, deductibles, co-insurance, etc., and therefore for brevity's sake, standard claim processing procedures will not be discussed.

Based on the allowance or partial allowance of the claim based on standard claim processing procedures, claim liability and a claim payment based on the HRA plan for a member is next determined (block 712). A claim payment is then made to the member or provider, as appropriate, as well as any explanation of benefits (EOB) and/or coordination of benefits (COB) information (block 714). Also, a record of the claim payment is stored for access by a member, provider, employer, health plan, etc. (block 716). A record of the claim payment is then available for display when accessed by a member, provider, employer, health plan, etc. (block 718).

Particularly, in one embodiment, as previously discussed, a member, provider, employer, or health plan may access this data utilizing a computing device over a network such as the Internet.

In one embodiment, as in FIG. 2, the claim processing system software module in conjunction with its respective defined contribution software module, as previously discussed, may be utilized to process claims including the integration of the previously described HRA functionality. EOBs and payments can be sent to either the provider and/or the member as appropriate. Further, typical claims processing functions that are available for COB apply to HRA claims processing as well. Further, claim liability and claim payment can also be calculated in conjunction with billing systems software module and its respective defined contribution software module in order to bill members, employers or other plan sponsors. Additionally, the claim processing system software module along with its defined contribution software module can also be utilized to aid in displaying claim payments and liability when accessed by member, providers, employers, health plans etc.

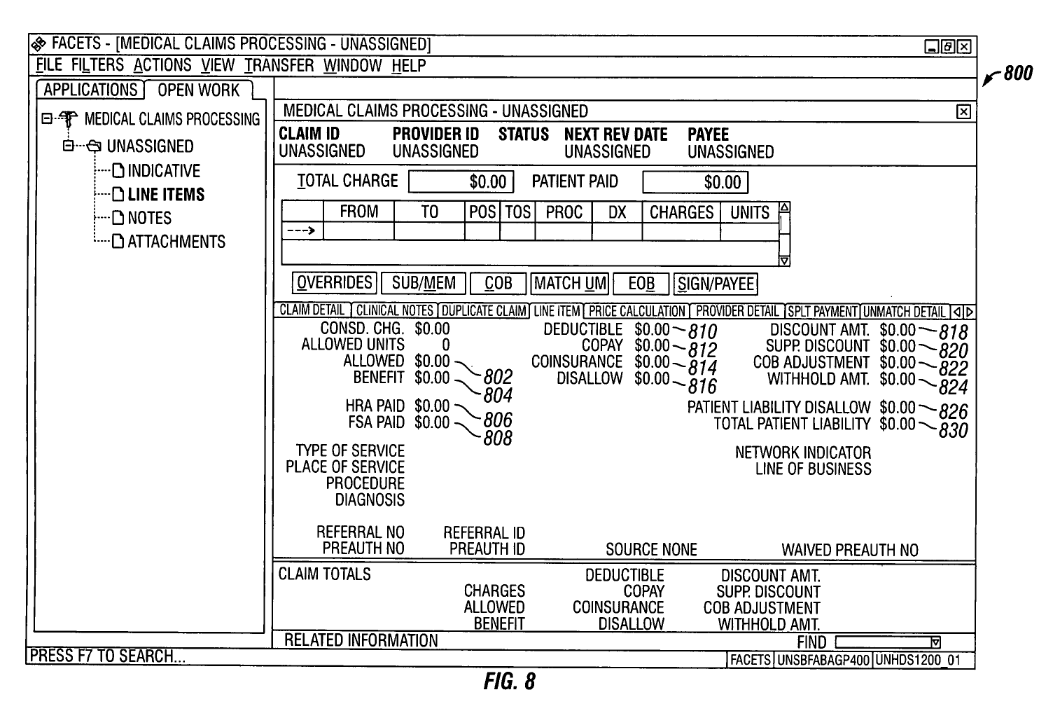

Turning now to FIG. 8, FIG. 8 illustrates a graphical user interface 800 that may be used in claims processing applications with an HRA or an FSA integrated with the health plan. As can be seen the graphical user interface 800 includes line items that illustrate components of claims processing including allowed amounts 802, benefit amounts 804, HRA paid amounts 806, FSA paid amounts 808, deductibles 810, co-pays 812, co-insurance 814, disallows 816, discounted amounts 818, supplemental discounted amounts 820, COB adjustments 822, withholding amounts 824, patient liability disallows 826, total patient liability 830, etc. It should be appreciated that graphical user interface 800 is just one example of an interface that can be used in claims processing including the integration of HRA and FSA accounts, as previously discussed.

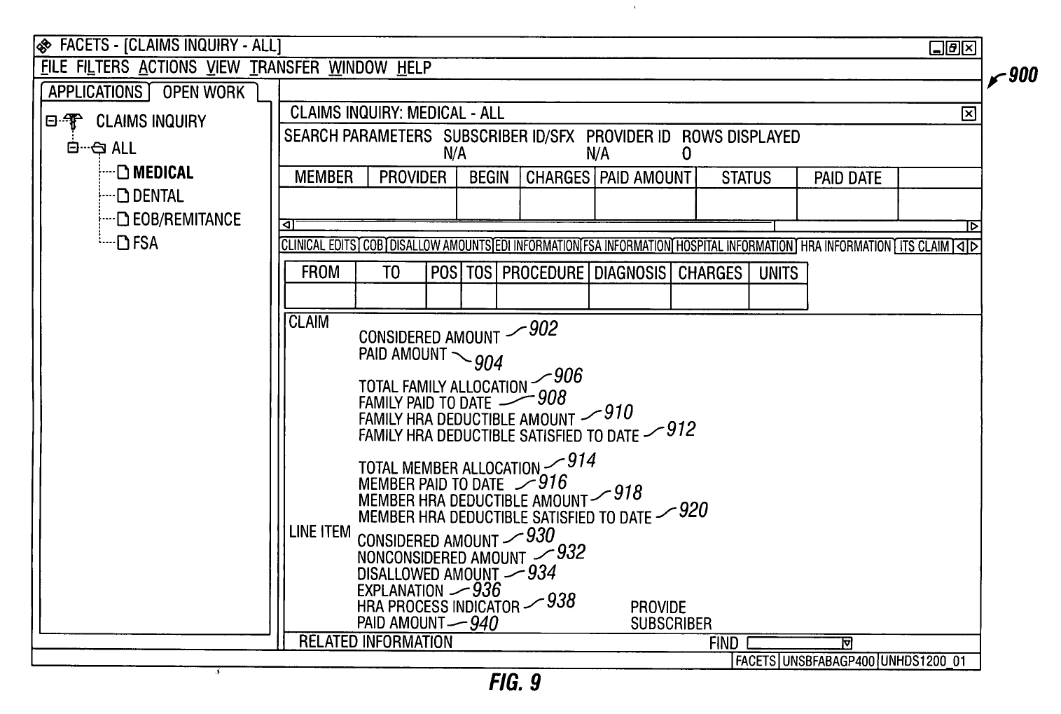

Referring now to FIG. 9, FIG. 9 illustrates an example of a graphical user interface 900 that may be accessed by a member, provider, employer, health plan, etc., in order to display claim payments and liabilities with regards to a health plan, particularly including HRA amounts. As can be seen in FIG. 9, claim information related to considered amounts 902, paid amounts 904, total family allocation 906, family paid-to-date 908, family HRA deductible amounts 910, family HRA deductible satisfied-to-date amounts 912, total member allocation amounts 914, member paid-to-date 916, member HRA deductible amounts 918, member HRA deductible satisfied-to-date amounts 920 may be displayed. Further, line items related to considered amounts 930, non-considered amounts 932, disallowed amounts 934, explanations 936, HRA process indicator 938, and paid amounts 940 may also be displayed.

Another type of defined contribution plan is a Flexible Spending Account (FSA). Flexible Spending Accounts allow members to contribute money on a pre-tax basis to an account that can be used both for health care expenses and dependent care. Members are reimbursed for eligible out-of-pocket expenses from the account, and any unused funds at the end of the year are forfeited. As will be described, embodiments of the invention provide for functionality related to: integrating FSAs with medical and/or dental plans; linking medical and/or dental plans to FSA accounts to accommodate automatic payment of eligible FSA services; allowing for enrollment into FSA plans; managing medical and dependent care FSA reimbursement accounts; providing paid claims and account balance inquiry tools; providing subscriber selectable automatic reimbursement for out-of-pocket amounts; etc.

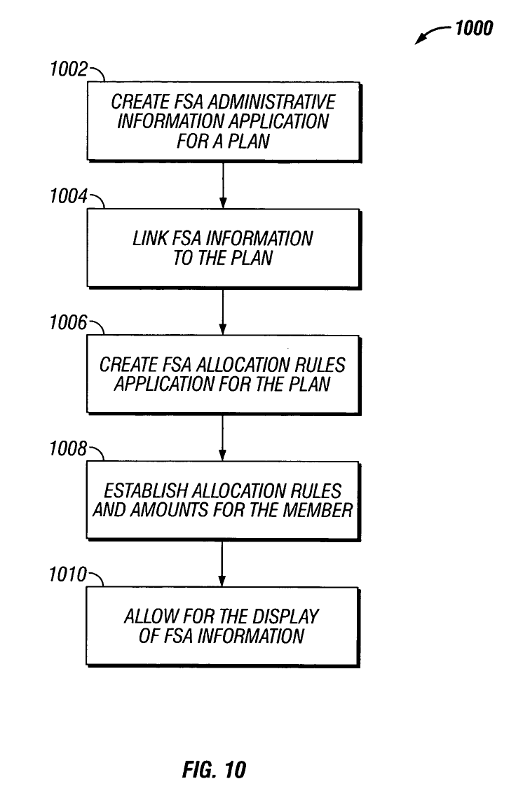

With reference now to FIG. 10, FIG. 10 is a flow diagram illustrating a process 1000 to implement the creation of an FSA plan in a health plan system integrating defined contribution functionality. In order to accommodate the setup of an FSA plan, an FSA administrative information application is created for a health plan (block 1002). The creation of the FSA administrative information application allows the FSA information to be linked to a particular health plan. Next, at block 1004, the FSA information is linked to the health plan. Further, an FSA allocation rules application is created for the health plan (block 1006). Next, allocation rules and amounts are established for a member of a health plan (block 1008). Further, FSA information is configured for display to members and employers who may access the information via a network.

In one embodiment, as in FIG. 2, the plan management system software module and the membership management system software module in conjunction with their respective defined contribution software modules, as previously discussed, may be utilized in the creation of the FSA administrative information application, the creation of the FSA allocation rules application, and the establishment of allocation rules and amounts for the FSA of the health plan.

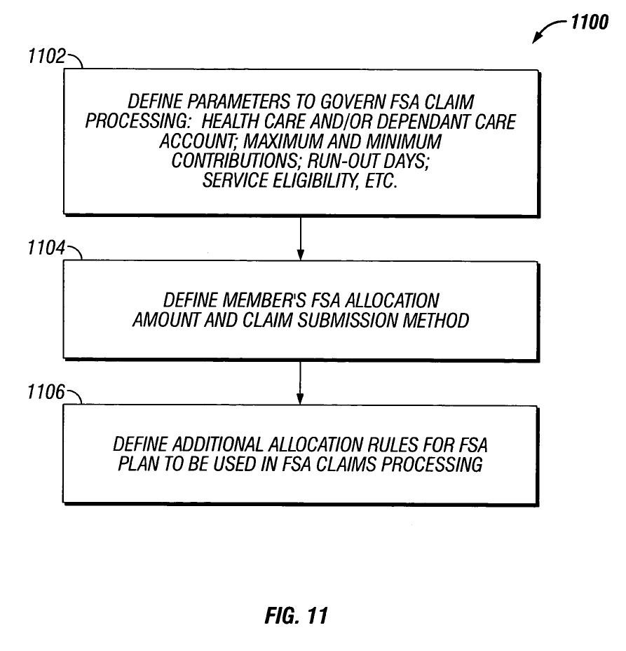

Turning now to FIG. 11, FIG. 11 is a flow diagram illustrating a process 1100 to establish allocation rules and amounts for a member of the health plan utilizing an FSA. In order to process an FSA transaction, parameters are defined that govern how FSA claims are processed. Particularly, parameters including health care and/or dependent care accounts, maximum and minimum contributions, run out days and service eligibility, are defined to govern how FSA claims are processed (block 1102). Next, for a particular member, FSA allocation amounts and claim submission methods are determined for a member (block 1104). For example, a member may select to be automatically reimbursed from the FSA for pre-designated items (e.g. co-pays) or a member may select to submit receipts for reimbursement. Further, additional allocation rules for the FSA plan to be used in FSA claims processing are defined (block 1106).

An FSA plan, as previously described, includes both a health care expense component and a dependent care expense component, or both. Run-out days and maximum and minimum pledge amounts as allowed by the IRS are defined for the FSA. If the employer provides additional matching contributions, they can also be defined as either a fixed amount or a percentage of the pledge amount. Further, indicators can also be set to determine whether a service is eligible for reimbursement from an FSA account. FSA expense categories include all the different types of services that may be covered under an FSA plan (such as dependent care, dental service, co-pay reimbursement, etc.), including any service for which a member would submit a manual claim to be paid.

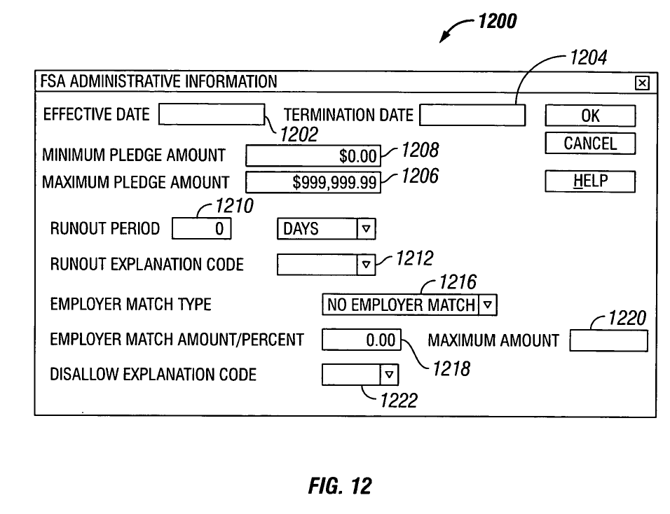

Turning now to FIG. 12, FIG. 12 shows an example of a graphical user interface 1200 that may be utilized in the creation of an FSA and particularly illustrates a user interface for FSA administrative functionality. As can be seen in FIG. 12, the user interface includes an effective date field 1202 to enter the date that the set of FSA administrative information became effective. A termination date field 1204 is provided that allows for the entry of a date that the set of FSA administrative information was terminated. A maximum pledge amount field 1206 is provided that allows for the entry of the highest amount that a subscriber can pledge for the FSA. A minimum pledge amount field 1208 is provided to allow for the entry of the lowest amount a member can pledge for the FSA.

Further, a run-out period entry field 1210 is provided to allow for the entry of the amount of time from the end of the year or from the termination date that FSA claims can still be accepted. A run-out explanation code field 1212 is also provided to allow for the selection of user-defined explanation codes to display for run-out claims denied due to run-out periods being exceeded.

An employer match type selection field 1216 is provided to allow for the selection of how employee funds are to be matched by the employer. The selection types may include no employer match, flat amount match, percent of employee match, etc. Further, an employer match amount/percent field 1218 is provided to allow for the selection of a dollar amount or percentage that employees will match. Further, maximum amount field 1220 may also be provided to allow for the entry of a maximum amount that the employer will be able to contribute when they are contributing a percentage of the employee contribution. Additionally, a disallow explanation code 1222 may also be provided to allow for the selection of user-defined explanation codes to value claims disallowed due to the FSA account being exhausted.

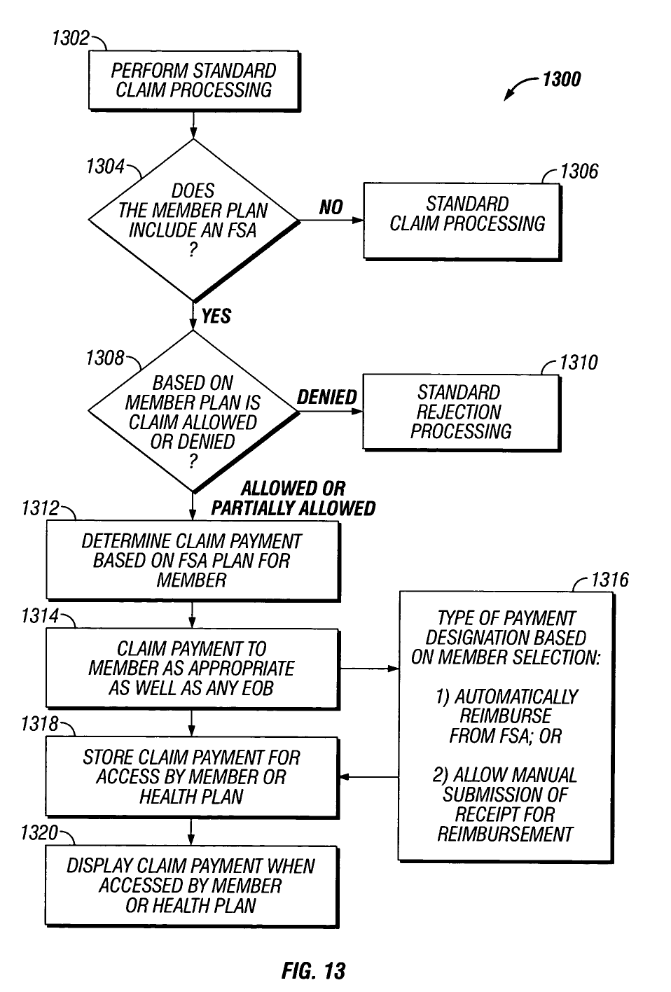

With reference now to FIG. 13, FIG. 13 is a flow diagram illustrating a process 1300 to perform claim processing with an FSA integrated with a health plan. At block 1302, standard claim processing is performed. Next, it is determined whether the member plan includes an FSA (block 1304). If not, standard claim processing is performed (block 1306).

If a member plan does include an FSA, then at block 1308 it is determined, based on the member plan, whether the claim is allowed or denied. If the claim is denied, standard claim rejection processing is performed (block 1310). However, if based on the member plan the claim is allowed or partially allowed, then claim liability and/or claim payment based on the FSA plan for the member is determined (block 1312). The claim payment is then made to the member as appropriate as well as any EOB (block 1314). Particularly, at block 1316, the type of payment designation based on member selection is chosen. These include automatic reimbursal from the FSA or the manual submission of receipts for reimbursement.

At block 1318, claim payments are stored for access by a member, provider or the health plan. Further, claim payments may be accessed by a member, provider or the health plan for display (block 1320). Similarly, in certain instances, claim payments may be accessed by employees, providers, or other entities. Further as previously discussed, FIG. 8 provides an example of a user interface for claims processing that accommodates both HRA and FSA processing in combination with traditional claims processing.

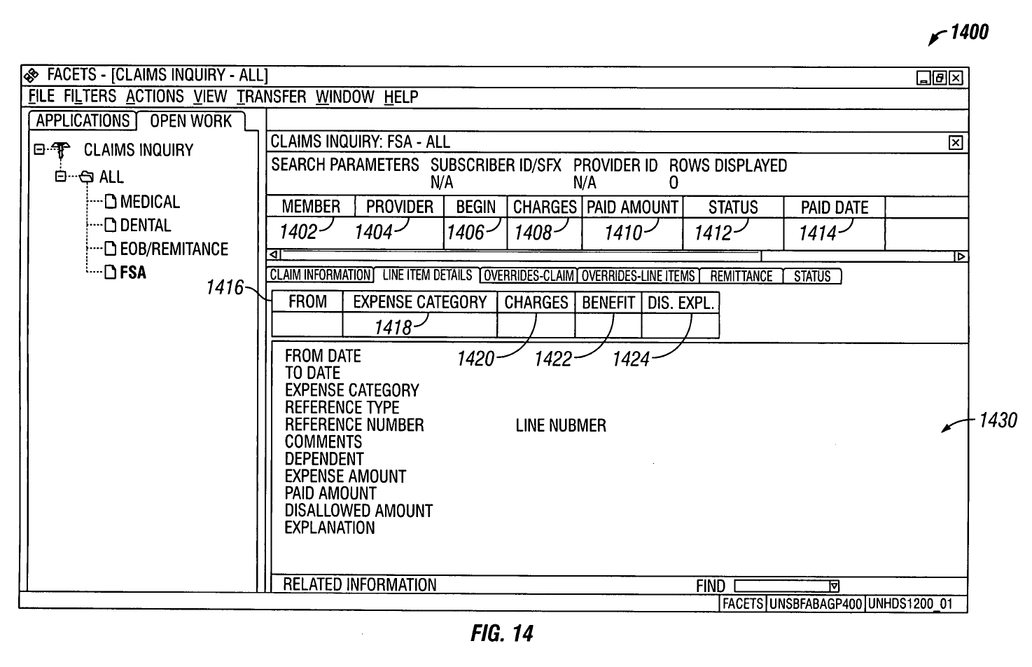

Turning to FIG. 14, FIG. 14 illustrates an example of a claim inquiry graphical user interface 1400 that may be accessed by a member or employer (or other entities with proper security access) to detail the status of a claim of an FSA account. As shown in FIG. 14, fields include member data 1402, provider data 1404, a begin date 1406, charges 1408, paid amount 1410, a status field 1412 and a paid date 1414. Further, the user interface 1400 includes a from date 1416, an expense category 1418, a charges field 1420, a benefit field 1422 and a disallowed amount explanation field 1424. This information can also be provided in line item form in window 1430.

Again, this type of data can be provided to a member, employer, provider, health plan, or other entity having a computing device across a network by conventional access means (e.g. member logging on to the health plan web-site).

As previously shown FSA claims can be processed jointly with, or separately from, HRA claims; and payments can be made to the member. FSA medical claims are paid to the total annual pledge amount, while dependent claims will be paid to the maximum of the year-to-date contribution amount. If the FSA dependent claim is greater than the year-to-date contribution amount, it will recycle automatically until the entire amount is paid. Based on options defined at the member level, covered FSA medical expenses can be automatically reimbursed when claims are processed under the member's medical plan. Alternatively, the member can opt to manually submit receipts, which can then be processed.

As previously described, embodiments of the invention provide for the full integration of defined contribution plans, such as FSAs and HRAs, into a centralized claim processing system of a health plan. Further, functionality is provided to allow for the creation and maintenance of FSAs and HRAs. Also, as previously discussed, employers, members, and other entities can monitor their defined contribution accounts online, such as through the Internet using a Web-Browser.

Further, as previously discussed, employers can determine allocation matching, carryover limits and calculations, and services available within HRA offerings that are not covered by traditional medical and dental plans. This allows employers to set pricing for the non-covered services for their employees and determine which services are not covered. The employer may also determine if deductibles, co-pays, co-insurance and patient liability disallows are reimbursable expenses. Further, health plans can determine the payment hierarchy between the HRA and FSA accounts, and specifically, from which account expenses are deducted first. Also, reports are available for members and employers to view HRA and FSA claim information.

While embodiments of the present invention and its various functional components have been described in particular embodiments, it should be appreciated that the embodiments of the present invention can be implemented in hardware, software, firmware, middleware or a combination thereof and utilized in systems, subsystems, components, or sub-components thereof. When implemented in software or firmware, the elements of the present invention are the instructions/code segments to perform the necessary tasks.

The instructions, programs, or code segments can be stored in a machine readable medium (e.g. a processor readable medium or a computer program product), or transmitted by a computer data signal embodied in a carrier wave, or a signal modulated by a carrier, over a transmission medium or communication link. The machine-readable medium may include any medium that can store or transfer information in a form readable and executable by a machine (e.g. a processor, a computer, etc.). Examples of the machine-readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, bar codes, etc. The code segments may be downloaded via networks such as the Internet, Intranet, etc.

Further, while embodiments of the invention have been described with reference to illustrative embodiments, these descriptions are not intended to be construed in a limiting sense. Various modifications of the illustrative embodiments, as well as other embodiments of the invention, which are apparent to persons skilled in the art to which embodiments of the invention pertain, are deemed to lie within the spirit and scope of the invention.

1. A system to integrate a defined contribution plan with a health plan comprising:
a claim processing system;
a health plan management software module; and
a defined contribution management software module integrated with the health plan management software module, both the health plan management and defined contribution software modules operable by the claim processing system to:
create a defined contribution application for the health plan to allow for the entry of information for the defined contribution plan;
link defined contribution plan information to the health plan; and
establish allocation rules and amounts for the defined contribution plan.

2. The system of claim 1, further comprising a claim processing defined contribution software module integrated with a health plan claim processing software module, both the health plan claim processing and defined contribution claim processing software modules operable by the claim processing system to:
perform claim processing; and
determine a claim payment for a member based on the defined contribution plan.

3. The system of claim 1, wherein the health plan claim processing and defined contribution claim processing software modules store a record of a claim payment for the defined contribution plan for access by a member, provider, employer, broker or employee of the health plan.

4. The system of claim 3, further comprising a network interface to couple the claim processing system to a network, wherein a member of the health plan utilizing a computing device accesses a record of a claim payment for the defined contribution plan through the network.

5. The system of claim 1, wherein the defined contribution plan is a Health Reimbursement Arrangement (HRA) account.

6. The system of claim 5, wherein establishing allocation rules and amounts for the HRA comprises defining parameters including at least one of copays, deductibles, coinsurance, and patient liability portions that are considered for payment by the HRA during claim processing.

7. The system of claim 5, wherein establishing allocation rules and amounts for the HRA comprises defining a member's allocation amount and tier.

8. The system of claim 5, wherein establishing allocation rules and amounts for the HRA comprises determining whether HRA allocated amounts are to be carried over.

9. The system of claim 1, wherein the defined contribution plan is a Flexible Spending Account (FSA) account.

10. The system of claim 9, wherein establishing allocation rules and amounts for the FSA comprises defining parameters including at least one of an FSA allocation amount and a claim submission method that are considered during FSA claim processing.

11. A method to integrate a defined contribution plan with a health plan comprising:
creating a defined contribution application for the health plan to allow for the entry of information for the defined contribution plan;
linking defined contribution plan information to the health plan; and
establishing allocation rules and amounts for the defined contribution plan.

12. The method of claim 11, further comprising performing claim processing utilizing the defined contribution plan.

13. The method of claim 12, wherein performing claim processing utilizing the defined contribution plan includes determining a claim payment to a member based on the defined contribution plan.

14. The method of claim 13, further comprising storing a record of a claim payment for the defined contribution plan for access by a member.

15. The method of claim 14, wherein a member, provider, employer, broker or employee of the health plan utilizing a computing device accesses a record of the claim payment for the defined contribution plan through a network.

16. The method of claim 11, wherein the defined contribution plan is a Health Reimbursement Arrangement (HRA) account.

17. The method of claim 16, wherein establishing allocation rules and amounts for the HRA comprises defining parameters including at least one of copays, deductibles, coinsurance, and patient liability portions that are considered for payment by the HRA during claim processing.

18. The method of claim 16, wherein establishing allocation rules and amounts for the HRA comprises defining a member's allocation amount and tier.

19. The method of claim 16, wherein establishing allocation rules and amounts for the HRA comprises determining whether HRA allocated amounts are to be carried over.

20. The method of claim 11, wherein the defined contribution plan is a Flexible Spending Account (FSA) account.

21. The method of claim 20, wherein establishing allocation rules and amounts for the FSA comprises defining parameters including at least one of an FSA allocation amount and a claim submission method that are considered during FSA claim processing.

22. A machine-readable medium having stored thereon instructions, which when executed by a machine, cause the machine to perform the following operations comprising:
creating a defined contribution application for the health plan to allow for the entry of information for the defined contribution plan;
linking defined contribution plan information to the health plan; and
establishing allocation rules and amounts for the defined contribution plan.

23. The machine-readable medium of claim 22, further comprising performing claim processing utilizing the defined contribution plan.

24. The machine-readable medium of claim 23, wherein performing claim processing utilizing the defined contribution plan includes determining a claim payment to a member based on the defined contribution plan.

25. The machine-readable medium of claim 24, further comprising storing a record of a claim payment for the defined contribution plan for access by a member.

26. The machine-readable medium of claim 25, wherein a member of the health plan utilizing a computing device accesses a record of the claim payment for the defined contribution plan through a network.

27. The machine-readable medium of claim 22, wherein the defined contribution plan is a Health Reimbursement Arrangement (HRA) account.

28. The machine-readable medium of claim 27, wherein establishing allocation rules and amounts for the HRA comprises defining parameters including at least of one copays, deductibles, coinsurance, and patient liability portions that are considered for payment by the HRA during claim processing.

29. The machine-readable medium of claim 27, wherein establishing allocation rules and amounts for the HRA comprises defining a member's allocation amount and tier.

30. The machine-readable medium of claim 27, wherein establishing allocation rules and amounts for the HRA comprises determining whether HRA allocated amounts are to be carried over.

31. The machine-readable medium of claim 22, wherein the defined contribution plan is a Flexible Spending Account (FSA) account.

32. The machine-readable medium of claim 31, wherein establishing allocation rules and amounts for the FSA comprises defining parameters including at least of one an FSA allocation amount and a claim submission method that are considered during FSA claim processing.
